(19) United States
(12) Patent Application Publication
(10) Pub. No.: US 2020/0398916 A1
(43) Pub. Date: Dec. 24, 2020

(54) PRODUCTION SYSTEM WITH AN AGV FOR AUTOMATICALLY DISCHARGING CONTAINERS TO PICKING SHELVES

(71) Applicant: Identytec GmbH & Co. KG, Hildesheim (DE)

(72) Inventor: Thorsten FINKE, Algermissen (DE)

(21) Appl. No.: 16/498,947

(22) PCT Filed: Mar. 14, 2018
(86) PCT No.: PCT/EP2018/056443

§ 371 Date: Aug. 19, 2020

(30) Foreign Application Priority Data
Mar. 20, 2017 (DE) 10 2017 105 950.4

(51) Int. Cl. B62D 65/18; G05D 1/02; B65G 1/08

(52) U.S. Cl. CPC B62D 65/18; G05D 1/0234; G05D 2201/0216; B65G 2203/044; B65G 2203/046; B65G 1/08

(57) ABSTRACT

Production system for series production, having a transport for transporting containers from a container storage area to picking shelves. Transport has an automated guided vehicle (AGV) on which a transport shelf is situated, and containers are automatically delivered or deliverable from transport shelf to picking shelves in a conveying direction (delivery direction). Transport shelf has a base body connected or connectable to AGV, and on which a carrier for containers to be transported is situated. Carrier is adjustably situated on base body, transversely with respect to delivery direction and parallel to an essentially horizontal plane. Carrier is adjustable relative to base body, and is designed in such a way that when an AGV is stationarily situated in front of a picking shelf, the position of the carrier relative to picking shelf is adjustable, transversely with respect to the delivery direction and parallel to essentially horizontal plane.

The invention relates to a production system for the series production of in particular motor vehicles.

The components used in the series production of motor vehicles are often classified into A, B, and C parts, the C parts being bulk material with no particular value. In particular C parts, which may be, for example, screws, nuts, or the like, are provided in material containers, also referred to below as containers for short. The containers generally each contain a large number of similar components.

The known production systems have a container storage area for storing the containers, which contain components intended for the production. In addition, the known production systems have picking shelves, remote from the container storage area, from which containers may be removed by workers. The picking shelves often have operating paths designed as an inclined plane, wherein a plurality of containers are situated in succession on an operating path, and material containers that are situated on the same operating path contain the same components. During the manufacturing process, initially the components are withdrawn from a material container in the front in the flow direction. When this material container is completely emptied, it may be removed from the operating path, so that material containers behind it slide down. Alternatively, it is also possible for a worker to remove a material container that is still full from the operating path, so that once again containers behind it may slide down.

Material demand planning takes place on a central apparatus or optionally multiple central apparatuses. One method for reporting material inventories to the individual picking shelves, for example, is to assign a card for material demand planning to each picking shelf. At regular intervals a worker or logistician checks the individual picking shelves for whether sufficient material is still available. If this is not the case, the worker or logistician removes the card, which is then brought to a central apparatus at which the material demand planning takes place. Within the scope of the material demand planning, a supplementary delivery of the appropriate material may then take place at the particular location.

To facilitate the reporting of material inventories to the central apparatus, it is known to use a so-called call button. Thus, when necessary, for example when the next to last material container is removed from an operating path, a worker actuates the call button so that a material request is initiated at the central apparatus, after which the depleted material may be delivered to the particular picking shelf. The reporting of a material demand to the central apparatus is thus automated by means of the call button.

To further automate the demand planning, it is known from DE 20 2007 01 2926 U1 to sense via a sensor means whether a container is present at a predetermined location on the picking shelf. For example and in particular, the sensor means may sense the position of at least one material container on the operating path of a picking shelf. The particular sensor means may be connected via radio, for example, to a central apparatus, and may thus automatically report a corresponding material demand to the central apparatus. In this way, the request for material containers may be automated, so that it has a particularly reliable design. Since the request for material containers no longer has to be made by the workers, their workload is relieved.

The known production systems also have a transport means for transporting containers from the container storage area to the picking shelves. The transport usually takes place in such a way that a transport vehicle is loaded with filled containers at a picking station, which is also referred to as a “depot” or a “supermarket.” After the loading, a driver drives the transport vehicle to the particular location where there is a material demand and at which a material container carried on the transport vehicle is to be inserted into the picking shelf. The insertion of the material container into the picking shelf is carried out by the logistician, who at the same time carries along the provided empty container to the picking shelves. After all containers are delivered, the logistician drives the transport vehicle back to the picking station, so that the transport vehicle may once again be loaded with filled material containers and the operation may be repeated.

A production system for the series production of in particular motor vehicles is known from EP 2 745 982 A2, having a container storage area for storing containers that contain components intended for the production, and a plurality of picking shelves, remote from the container storage area, from which components may be removed from containers by workers. The known production system also has a transport means for transporting containers from the container storage area to the picking shelf, wherein the transport means has at least one automated guided vehicle (AGV) that is designed and configured in such a way that containers are or may be automatically delivered to picking shelves in a conveying direction (delivery direction).

The production system known from the cited publication achieves the entire logistical object of fully automatically transporting material from a storage area of the production system to picking shelves, according to the particular need.

The object of the invention is to further reduce the susceptibility of the known production system to malfunctions.

This object is achieved by the invention set forth in claim 1.

The invention provides that the transport shelf has a base body that is or may be connected to the chassis of the AGV, and on which a carrier for containers to be transported is situated, wherein the carrier is adjustably situated relative to the base body, transversely with respect to the delivery direction and parallel to an essentially horizontal plane, and wherein a means for adjusting the carrier relative to the chassis is provided, and is designed in such a way that when an AGV is stationarily situated in front of a picking shelf, the position of the carrier relative to the picking shelf is adjustable transversely with respect to the delivery direction and parallel to an essentially horizontal plane. The delivery direction is defined by a trajectory along which a container moves from the transport shelf to the picking shelf during the delivery.

To deliver a container from the transport shelf, situated on the AGV, to a picking shelf, the AGV is moved into a position in front of the picking shelf which with regard to the lateral orientation of the AGV with respect to the picking shelf ideally corresponds to a setpoint position relative to the picking shelf. In the setpoint position of the AGV and thus of the carrier, a delivery path of the carrier is in flush or approximately flush alignment with a receiving path on the picking shelf. The delivery path is defined by a delivery chute that is formed on the carrier, and the receiving path is defined by a storage chute that is formed on the picking shelf.

In practice, each delivery chute or storage chute is formed in each case by two laterally spaced-apart rails, at or on which the containers are or may be guided.

The invention is based on the finding that malfunctions of the production system may occur during the delivery of containers from the AGV to a picking shelf when the rails of the delivery chute are not oriented transversely relative to the delivery direction, i.e., laterally, with respect to the rails of the storage chute with the required accuracy.

On this basis, the underlying concept of the invention is to further improve the functional reliability of the production system according to the invention and further reduce its susceptibility to malfunctions, in that for an AGV that is stationarily situated in front of a picking shelf, the option is provided for a fine adjustment or setting of the position of the carrier transverse to the delivery direction and parallel to an essentially horizontal plane, i.e., a lateral fine adjustment or setting.

For this purpose, the invention provides that the transport shelf has a two-part design and has a base body and a carrier adjustably situated on the base body, transversely with respect to the delivery direction and parallel to an essentially horizontal plane, and a means for adjusting the carrier relative to the base body is provided.

In a production system according to the invention, the AGV moves in the direction of the particular picking shelf and stops in front of it. The traction drive of the AGV is controlled in such a way that the actual position of the AGV that is reached in front of the picking shelf after the travel motion ends corresponds as closely as possible to a setpoint position, in which the delivery chute of the transport shelf situated on the AGV is in flush alignment, with the required accuracy, with respect to the associated storage chute of the picking shelf, i.e., the delivery chute is oriented laterally with respect to the storage chute.

If the actual position corresponds to the setpoint position with sufficient accuracy for trouble-free delivery of a container from the transport shelf to the picking shelf, the container may be immediately delivered to the picking shelf.

On the other hand, if the actual position does not correspond to the required accuracy of the setpoint position, according to the invention the carrier is adjusted transversely with respect to the delivery direction and parallel to an essentially horizontal plane, i.e., laterally, relative to the chassis until the actual position of the carrier corresponds to the setpoint position with the required accuracy.

In other words, lateral rough positioning of the carrier relative to the picking shelf initially takes place by means of the traction drive of the AGV. Lateral fine positioning of the carrier, if necessary, may then be carried out by adjusting the carrier relative to the chassis with the AGV stationary.

In this way, mispositioning of the carrier relative to the picking shelf is reliably prevented from causing a malfunction of the production system. The functional reliability of the production system according to the invention is thus further increased, and its susceptibility to malfunctions is reduced.

The fine positioning of the carrier by adjusting it relative to the carrier of the transport shelf situated on the AGV may take place rapidly and with high precision.

Due to the adjustability of the carrier relative to the base body of the transport shelf, the invention allows trouble-free delivery of containers from the AGV to a picking shelf, even when sufficiently precise positioning of the transport shelf in front of the picking shelf by appropriately controlling the traction drive of the AGV cannot be ensured. This may be the case, for example, when the navigation method used for the AGV by design does not allow sufficiently accurate fine positioning. The invention allows trouble-free delivery of containers from the AGV to picking shelves, even when unusual operating states of the AGV as an exception prevent sufficiently accurate positioning.

One advantageous further embodiment of the invention provides that the means for adjusting the carrier is designed in such a way that, when the AGV is stationarily situated in front of the picking shelf, the means, starting from an actual position, adjusts the carrier relative to the picking shelf into a setpoint position.

Another advantageous further embodiment of the invention provides that in the setpoint position of the carrier, a delivery path of the carrier is in flush or approximately flush alignment with a receiving path on the picking shelf. Within the meaning of the invention, “approximately flush alignment” is understood to mean that the delivery path and the receiving path are oriented relative to one another to an extent that remaining misalignments do not hinder the delivery of a container from the AGV to the picking shelf.

Another advantageous further embodiment provides that the delivery path is defined by a delivery chute that is formed on the carrier of the transport shelf, and the receiving path is defined by a storage chute that is formed on the picking shelf.

According to another advantageous further embodiment of the invention, each delivery chute or receiving chute is defined by two laterally spaced-apart rails at or on which the containers are or may be guided.

According to the invention, the adjustment of the carrier relative to the base body of the transport shelf may take place in any suitable manner. To allow particularly accurate positioning of the carrier relative to the chassis, one advantageous further embodiment of the invention provides that a drive means is associated with the carrier for adjusting it relative to the chassis, wherein a control means for controlling the drive means is provided.

With regard to automation of the operations in the positioning of the carrier relative to a picking shelf, another advantageous further embodiment of the invention provides that the control means is designed and configured for automatically actuating the drive means in such a way that when an AGV is stationarily situated in front of a picking shelf, the carrier, starting from an actual position, is or adjusted to a setpoint position relative to the picking shelf.

The drive means in the above-mentioned embodiment may have any suitable design. Since electrical energy is already available on the AGV, for example for supplying the traction drive and the controller of the AGV, in this regard one advantageous further embodiment of the invention provides that the drive means has at least one electromotive drive.

One advantageous further embodiment of the above-mentioned embodiment provides that the drive has a spindle drive that is in rotary drive connection with an electric motor. Such spindle drives are available as robust, relatively inexpensive standard units, and allow exact (fine) positioning of the carrier.

Another advantageous further embodiment of the invention provides a means for determining the actual position of the AGV relative to the picking shelf, and which is in data transmission connection with the control means of the drive means. In this embodiment, the actual position of the AGV, and thus of the carrier, relative to the picking shelf is determined and transmitted to the control means, which then controls the drive means for the carrier in such a way that the carrier is moved into the setpoint position.

One advantageous further embodiment of the above-mentioned embodiment provides that the means for determining the actual position of the AGV has a sensor means for scanning at least one feature on the picking shelf. In this embodiment, the actual position of the AGV is determined by scanning a feature on the picking shelf.

In the above-mentioned embodiment, the sensor means may operate according to any given operating principle. In this regard, one advantageous further embodiment of the invention provides that the sensor means has an optical sensor means. Such an optical sensor means is available in many different embodiments, and allows an exact determination of the actual position of the AGV.

One advantageous further embodiment of the above-mentioned embodiment provides that the optical sensor means has at least one camera. Such cameras in the form of digital cameras are available as relatively simple, inexpensive units, and may be used, for example, to record motion or still images of the picking shelf during the movement of the AGV relative to the picking shelf, and to determine the actual position of the AGV relative to the picking shelf by use of image processing and pattern recognition methods, based on the recorded motion or still images.

Another advantageous further embodiment of the invention provides that the optical sensor means has at least one laser that is designed for scanning an optical feature on the picking shelf. Such lasers are available as relatively inexpensive standard units with a high level of functional reliability. The laser may, for example, scan position marks affixed to the picking shelves. However, for position determination it is also possible, for example, for the laser to scan a rail of a storage chute on a picking shelf.

One advantageous further embodiment of the invention that has independent inventive importance taken alone, even without the adjustability, provided according to the invention, of the carrier relative to the base body of the transport shelf, provides that the travel controller of the AGV is programmed in such a way that the travel direction of the AGV is transverse to the delivery direction, such that upon approaching the particular picking shelf, the AGV moves crosswise relative to the delivery direction. In this way, the positioning of the AGV relative to the shelf is facilitated, and the risk of a collision of the AGV with the picking shelf is reduced, which would be a concern if the AGV were to travel toward the picking shelf from the front.

One advantageous further embodiment of the above-mentioned embodiment provides that the sensor means is designed and programmed for detecting, during the crosswise travel, at least one feature on the picking shelf that characterizes the setpoint position.

Another further embodiment of the invention provides that the means for determining the actual position of the AGV relative to the picking shelf is in data transmission connection with the travel controller of the AGV.

The transport shelf may be fixedly connected to the AGV. However, one advantageous further embodiment of the invention that has independent inventive importance taken alone, even without the adjustability, provided according to the invention, of the carrier relative to the chassis of the AGV, provides that the AGV is formed by a self-driving forklift that carries the transport shelf.

The invention is explained in greater detail below with reference to the appended drawings, in which one embodiment of a production system according to the invention is schematically illustrated, sometimes in the form of a sketch. All features that are described, illustrated in the drawings, and claimed in the patent claims, alone or in any arbitrary combination, constitute the subject matter of the invention, regardless of their recapitulation in the patent claims or their back-reference, and regardless of their wording or illustration in the description or drawings, respectively.

In the Figures:

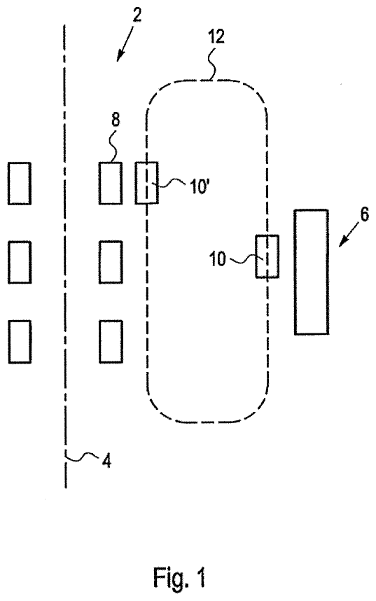

FIG. 1 shows a highly schematic sketch of a topology of a production system 2 according to the invention,

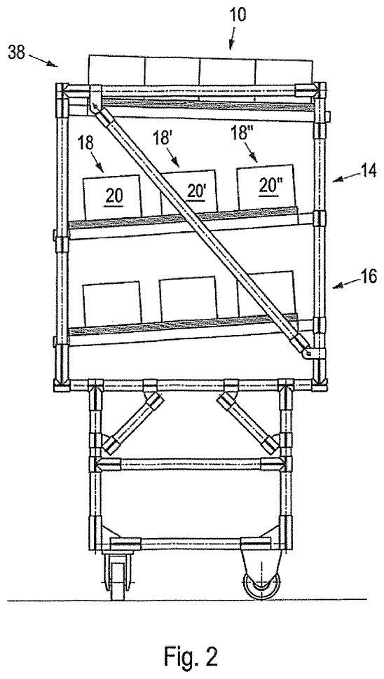

FIG. 2 shows a schematic view from the rear of one embodiment of an AGV according to the invention,

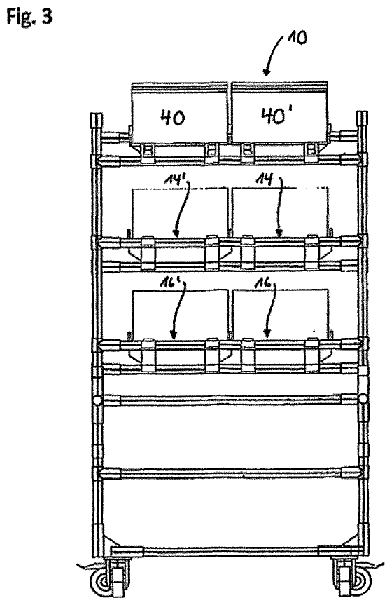

FIG. 3 shows the AGV according to FIG. 2 in a side view,

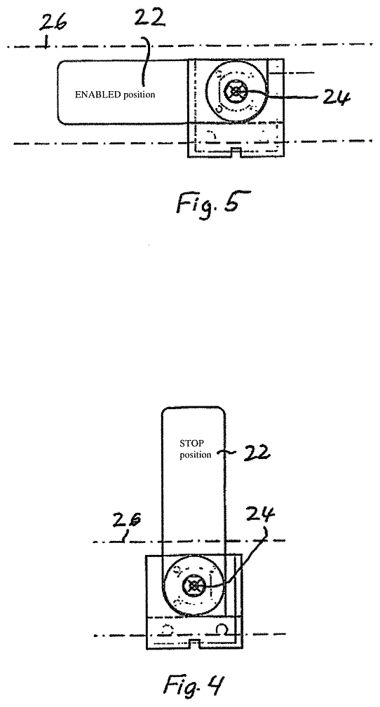

FIG. 4 shows a view from the front of a blocking element of an AGV according to the invention in its blocking position,

FIG. 5 shows the blocking element in its delivery position, in an illustration similar to

FIG. 4,

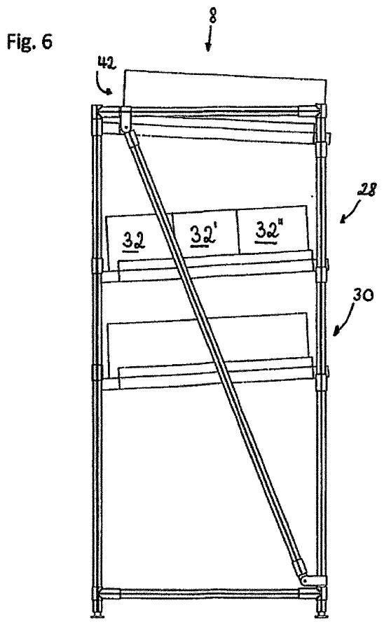

FIG. 6 shows one embodiment of a picking shelf of the production system according to FIG. 2, in the same illustration as for FIG. 2,

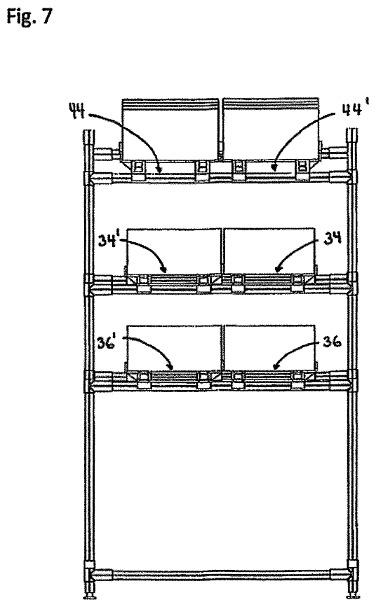

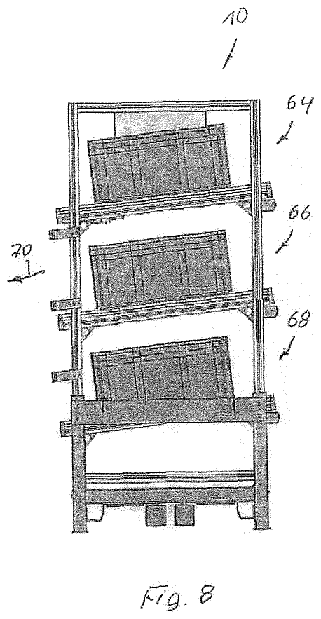

FIG. 7 shows a side view of the picking shelf according to FIG. 6,

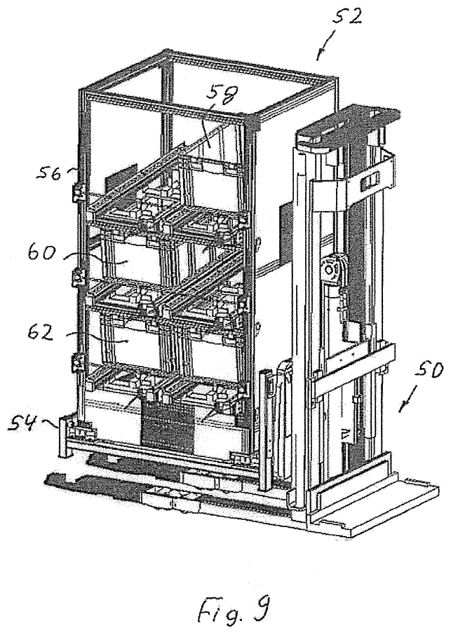

FIG. 8 shows another embodiment of an AGV according to the invention of a production system, in an illustration similar to FIG. 2,

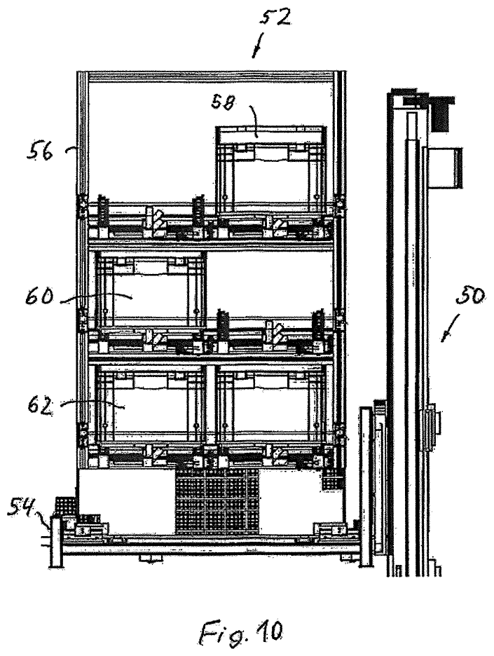

FIG. 9 shows a perspective view of the AGV according to FIG. 8,

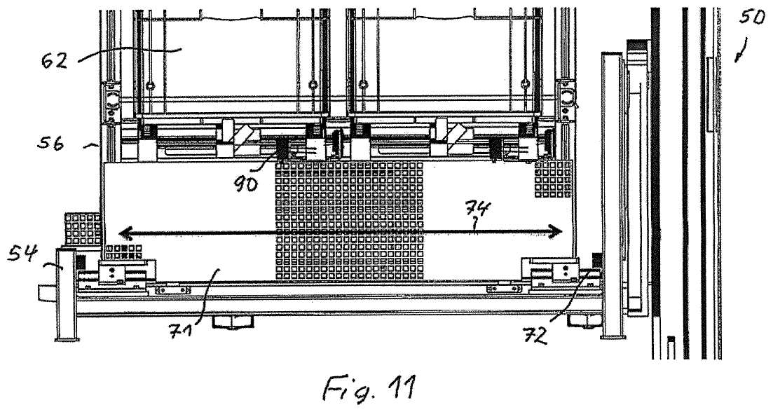

FIG. 10 shows a side view of the AGV according to FIG. 9,

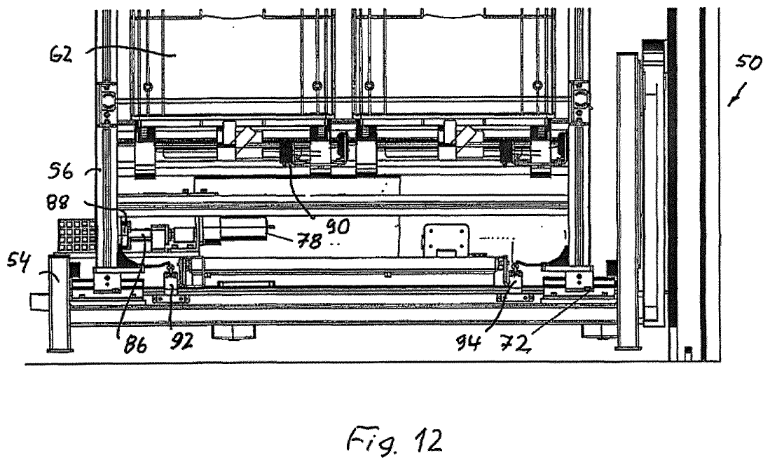

FIG. 11 shows a detail of the AGV according to FIGS. 9 and 10, in enlarged scale compared to FIG. 10, in the area of a connection of the base body of a transport shelf to the carrier,

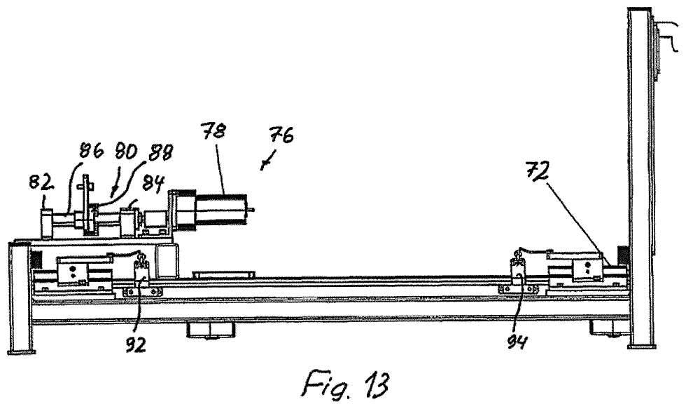

FIG. 12 shows an illustration similar to FIG. 11, with a covering of the base body omitted for reasons of clarity,

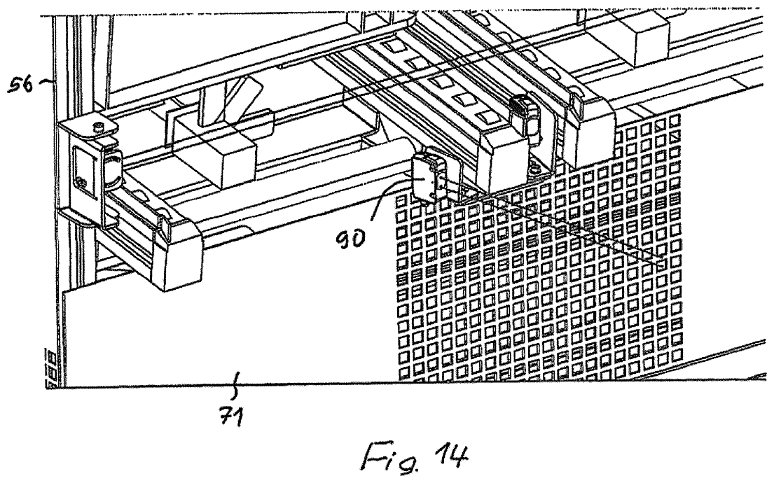

FIG. 13 shows an illustration similar to FIG. 11, with further components of the transport shelf omitted for reasons of clarity, and

FIG. 14 shows a perspective view of a detail from FIG. 11.

The drawings in part are highly schematic in the form of sketches, and the detail is reduced considerably to the level essential for understanding the invention.

FIG. 1 is a highly schematic illustration of a production system 2 for the series production in particular of motor vehicles, having an assembly line symbolized by a dash-dotted line 4 in FIG. 1.

In the series production of motor vehicles, so-called A, B, and C parts are used, the C parts being bulk material with no particular value. In particular C parts are delivered in material containers, also referred to below as containers for short. The production system 2 has a container storage area 6 for storing containers that contain components intended for the production. Picking shelves are situated on both sides of the assembly line 4, remote from the container storage area 6, from which containers containing components may be removed by workers. Only one picking shelf by way of example is provided with reference numeral 8 in FIG. 1.

One important logistical task is to ensure that in the production system 2, a sufficient number of containers containing components necessary for the production are always available on the picking shelves 8. One logistical subtask is to transport containers, filled with components, from the container storage area 6 to the picking shelves 8, and to deliver them to the containers corresponding to the individual picking shelves 8, depending on the need for components. For transporting containers from the container storage area 6 to the picking shelves 8, a transport means is provided, which according to the invention has at least one automated guided vehicle (AGV) within the scope of an automated guided system (AGS). A single individual AGV is indicated strictly symbolically in FIG. 1 and provided with reference numeral 10. However, a plurality of AGVs may be provided in the production system 2, depending on the particular requirements.

According to the invention, at least one AGV 10 is configured and designed in such a way that containers are or may be automatically delivered to the picking shelves 8.

The AGV 8 is controlled via radio by a central apparatus, for example a central control computer, by means of which all logistical operations within the production system are coordinated, in the illustrated embodiment the radio connection being established via a WLAN.

The AGV 10 is controllable in the container storage area 6 into a loading position, shown in FIG. 1, in which the AGV 10 is loaded with filled containers. The loading of the AGV 10 with filled containers may take place manually by a logistician. This embodiment has the advantage that the container storage area 6 does not have to be changed in order to make use of the invention. However, according to the invention a means for automatically or semiautomatically loading the AGV 10 with filled containers may also be provided in the loading area. According to the invention, this means may be provided, for example, by a handling apparatus or in some other way.

To report a need for components to one of the picking shelves 8, a sensor means is provided at at least one picking shelf 8 which senses whether a container is present at a predetermined location on the picking shelf. The sensor means may have an optical sensor or at least one electromechanically operating sensor, for example, as known from DE 20 2007 012926 U1, for example, the contents of which are hereby incorporated in full into the present patent application.

An operating path is formed on each of the picking shelves 8, and in particular may be designed as a roller conveyor and as an inclined plane, and runs on the container in which the components necessary for the series production are accommodated. Containers that are situated on the same operating path, and thus in the same picking shelf, are generally the same components.

With regard to one embodiment of an electromechanically operating sensor of the sensor means, reference is made once again to DE 20 2007 012926 U1, in which it is shown and described that a probe of an electromechanically operating sensor protrudes into the operating path in order to sense whether a material container is present at that time at the location where the sensor is situated. However, it is also possible for a worker to place an empty material container on a deposition surface provided for this purpose, and for a determination to be made via an appropriate sensor means whether a material container is present at that time on this deposition surface, and accordingly, there is a need for a supplementary delivery of components.

According to the invention, the sensor means may generate a requirement notification signal when no container is present at the predetermined location, for example on the picking shelf. The requirement notification signal is transmitted via radio to the central apparatus for material demand planning. A plurality of signals that indicate a need for different components at different locations in the production process thus pass to the central apparatus.

A route of the AGV 10 is symbolized by a dashed line 12 in FIG. 1, this route leading in a loop from the container storage area 6 to the picking shelves 8. Any given routes may be provided according to the invention, depending on the particular requirements. The manner in which an AGV travels along a predetermined route and is controlled is generally known to those skilled in the art, and therefore is not explained in greater detail here.

According to the invention, a transport trip of the AGV 10 may be initiated, for example, as a function of at least one requirement notification signal of the sensor means provided on the picking shelves 8. The logistical task of transporting material in containers in a timely manner to the picking shelves in such a way that there are always a sufficient number of the necessary components available here, but at the same time, designing transport trips of the AGV to be as economical as possible, for example by approaching different picking shelves 8 during a transport trip and at that location delivering containers containing different materials, is achieved by appropriate control in the central apparatus.

However, it is also possible according to the invention to initiate a transport trip of the AGV 10 as a function of at least one requirement control signal of the central apparatus for material demand planning. For example, the material demand at the individual locations in the production process, and thus at the individual picking shelves 8, may be estimated based on the advancement in the production process, wherein components are delivered in appropriate containers to the individual picking shelves 8, based on the estimate, in accordance with a safety reserve if necessary.

According to the invention, a requirement control may be triggered by a logistician occasionally checking the individual picking shelves as to whether a sufficient number of components are still available. A material demand may be communicated to the central apparatus via a suitable technical means, for example via material demand cards which are provided on the individual picking shelves, and which for indicating a material demand may be removed and transmitted to the central apparatus.

According to the invention, in a production system the above-described types of requirement notification may also be combined with one another, and optionally also with other methods for requirement notification, at the central apparatus.

The AGV 10 is loaded with filled containers in the loading area, wherein the loading area, for example and in particular, may be formed in the container storage area.

In the loading area, filled containers are scanned before loading the AGV 10; a scanning means for scanning the containers is provided in the loading area for this purpose. In the illustrated embodiment, the scanning means has a scanner for optoelectronically readable characters, in particular a barcode. However, the filled containers may also be scanned in some other way for detection prior to loading of the AGV. For example, the scanning means may have at least one camera.

Thus, for example, within the scope of the method according to the invention a barcode may be affixed to each container. The barcode may be permanently affixed to the container when the same parts are always transported in this container. However, it is also possible to transport different components in the same container during different transport trips of the AGV. An individual barcode is then affixed to each container in accordance with its contents. The particular container is detected by scanning and may be loaded onto the AGV 10.

The design of one embodiment of an AGV according to the invention is explained in greater detail below with reference to FIGS. 2 and 3.

FIG. 2 shows a rear view of the AGV 10. According to the invention, the AGV 10 is configured and designed in such a way that containers may be automatically delivered to the picking shelves 8.

After the AGV 10 has been loaded, the central apparatus controls it in such a way that the AGV 10 travels from the loading position to a delivery position, specified by the central apparatus, for delivery of loaded, filled containers to at least one picking shelf 8.

In the illustrated embodiment, the delivery means is designed as a passive delivery means and is controlled by the central apparatus.

The delivery means on the AGV 10 has at least one delivery chute on which containers may be situated one behind the other at at least two positions. It is apparent from FIG. 2 that in the illustrated embodiment two delivery chutes 14, 16 are situated one above the other. It is apparent from FIG. 3 that a further delivery chute 14′ is situated next to the delivery chute 14, and a further delivery chute 16′ is situated next to the delivery chute 16. Only the delivery chute 14 is described in greater detail below. The delivery chutes 16 and 14′ and 16′ have a similar design, and therefore are not explained in greater detail here.

As is apparent from FIG. 2, the delivery chute 14 is designed as an inclined plane. The delivery chute 14 is also designed as a roller conveyor to facilitate delivery of containers from the delivery chute 14.

As is also apparent from FIG. 2, containers 20, 20′, 20″ are situated in succession at three positions 18, 18′, 18″, respectively, in the delivery chute 14. The number of positions 18, 18′, 18″ for each delivery chute 14 is selectable within a wide range, depending on the particular requirements. Similarly, the number of adjacently situated delivery chutes 14, 14′ and 16, 16′ and the number of superposed delivery chutes 14, 16 and 14′, 16′ are selectable within a wide range. Ultimately, the number of positions 18 at which the AGV 10 can be loaded with a container 20 is a function solely of the dimensions of the AGV 10.

According to the invention, at least one blocking element is associated with each delivery chute 14, the blocking element being movable from a blocking position, in which the delivery chute 14 is blocked from delivery of containers, and a delivery position, in which the delivery chute is enabled for delivery of containers.

One embodiment of such a blocking element is illustrated in FIGS. 4 and 5, wherein FIG. 4 illustrates the blocking element in its blocking position, and FIG. 5 illustrates the blocking element in its delivery position.

In the present embodiment, the blocking element is designed as a locking bar 22 that is pivotable about a pivot axis 24 by means of an electromotive rotary drive. In the blocking position illustrated in FIG. 4, the locking bar protrudes into the delivery chute 14 so that the delivery chute is blocked from delivering containers. To allow containers to be delivered form the delivery chute 14, the locking bar 22 is pivoted by means of the associated electromotive rotary drive into the delivery position illustrated in FIG. 5, in which the delivery chute 14 is enabled for delivering the containers 20, 20′, 20″. Actuation of the electromotive rotary drive of the locking bar 22 may be controlled by the central apparatus or by a controller provided on the AGV 10, depending on the particular requirements.

If the delivery chute 14 is “type-sorted,” i.e., loaded solely with containers that contain the same components, according to the invention it is sufficient for a single blocking element 22, situated at the front end of the delivery chute 14 in the delivery direction, i.e., at the left end of the delivery chute 14 in FIG. 2, to be associated with the delivery chute 14.

To also allow loading that is not “type-sorted,” in which the containers situated in the delivery chute 14 contain different components, in the illustrated embodiment a separation means is assigned for individually delivering containers from the delivery chute 14. The separation means is designed in that a blocking element is associated with each of the individual positions 18, 18′, 18″ of the delivery chute 14, as illustrated in FIGS. 4 and 5. The blocking elements associated with the positions 18, 18′, 18″ are controllable independently of one another.

The loading of an AGV 10 is completed as follows:

For loading, the AGV 10 is controlled into a loading position in which it is situated, for example, in front of the container storage area 6. A logistician removes containers from the container storage area 6 that are to be loaded onto the AGV 10. The barcode provided on each container is initially scanned. To facilitate the loading, a display means is provided in the loading area for displaying a position on the AGV 10 that is provided for the particular container.

In the illustrated embodiment, the display means has a touchscreen on which the AGV 10 is symbolically depicted. After the barcode of a container is scanned, the particular position in the particular delivery chute of the AGV 10 where the container is to be positioned is displayed on the touchscreen. The logistician then places the container at the displayed position and confirms the partial loading operation, thus performed, on the touchscreen.

A further container may then be scanned and loaded onto the AGV 10. This partial loading operation is repeated until all containers to be transported by the AGV 10 in the pending transport trip have been loaded onto the AGV 10 or all positions of the AGV 10 are occupied with containers.

The distribution of containers on an AGV 10 or a plurality of AGVs is controlled by the central apparatus.

The containers to be loaded onto the AGV 10 may also be identified in some other way than a barcode or other types of optoelectronically readable characters. For example, the containers may be scanned using a camera, or the individual containers may be provided with a transponder, for example an RFID transponder. A locating means for automatically identifying and/or locating containers on the AGV 10 may be provided to check the arrangement of the containers on the AGV 10. In one embodiment in which the individual containers are provided with an RFID transponder, this locating means may have a reading apparatus for the transponder situated on the particular container. The correct loading of the AGV 10 with containers may be checked in this way.

After loading is completed, the central apparatus controls the AGV 10 in such a way that the AGV travels from the loading position to a delivery position, specified by the central apparatus, for delivery of loaded, filled containers to at least one picking shelf 8.

FIG. 6 shows the picking shelf 8 in a side view, while FIG. 7 illustrates the picking shelf 8 in a view from the front. The picking shelf 8 has storage chutes 28, 30 situated one on top of the other, which, analogously to the delivery chutes 14, 16 of the AGV 10, may be designed as an inclined plane with a roller conveyor. FIGS. 6 and 7 illustrate the picking shelf 8 in a state in which it is filled with containers, of which three containers are denoted by reference numerals 32, 32′, 32″ by way of example in FIG. 6. As is apparent from FIG. 7, two operating paths 34, 34′ and 36, 36′ are in each case situated next to one another in the storage chutes 28, 30, respectively.

To automatically deliver the container 20, for example, from the delivery chute 14 of the AGV 10 to the storage chute 28 of the picking shelf 8, the AGV is positioned by the central apparatus, optionally with the assistance of a controller provided on the AGV 10, in front of the picking shelf 8 in such a way that the delivery chute 14 of the AGV 10 is in flush alignment with the storage chute 28 of the picking shelf 8.

In this delivery position, the locking bar associated with the position 18 in the delivery chute 14 is controlled from the blocking position illustrated in FIG. 4 into the delivery position illustrated in FIG. 5, so that the container 20 rolls down over the roller conveyor of the delivery chute 14, designed as an inclined plane, by the action of gravity and is delivered into the storage chute 28 of the picking shelf 8. Since the locking bars associated with the positions 18′, 18″ of the delivery chute 14 are still in their blocking position, the containers 20′, 20″ remain in the delivery chute 14. However, if necessary, depending on the particular material demand on the picking shelf 8, the containers 20′, 20″ may also be delivered, at the same time as the container 20 or subsequently, to the storage chute 28 of the picking shelf 8.

A sensor means may be provided to check that one or more containers have actually been delivered to the picking shelf 8 in the desired manner.

In the illustrated embodiment, the AGV 10 is designed for accommodating empty containers on the picking shelves 8. As is apparent from FIGS. 2 and 3, the AGV 10 has a receiving chute 38 for empty containers above the delivery chute 14. It is apparent from FIG. 3 that two operating paths 40, 40′ are adjacently situated in the receiving chute 38. The operating paths 40, 40′ have a design analogous to the delivery chutes 14 of the AGV, and are each designed in the manner of an inclined plane having a roller conveyor, the inclination of the inclined plane of the receiving chute 38 being opposite that of the delivery chute 14.

As is apparent from FIG. 6, for example, a delivery chute 42 having two laterally adjacent operating paths 44, 44′ is situated on the picking shelf 8 (see FIG. 7). The operating paths 44, 44′, analogously to the delivery chutes 14, 16 of the AGV 10 and the storage chutes 28, 30 of the picking shelf 8, are designed as an inclined plane with roller conveyors, the inclination of the inclined plane being opposite that of the storage chutes 28, 30.

The delivery of empty containers from the delivery chute 42 of the picking shelf 8 to the receiving chute 38 of the AGV 10 may take place simultaneously with the delivery of containers from the AGV 10 to the picking shelf 8, or before or after same.

In the sense of an automatic delivery of the empty containers to the AGV 10, a blocking element, for example, may be associated with the delivery chute 42 of the picking shelf 8, as described with regard to the AGV 10 with reference to FIGS. 5 and 6. For example, the operating path 44 for delivering empty containers to the AGV 10 may be enabled by appropriate control, the empty containers then moving over the roller conveyor, to the right in FIG. 6, due to gravity and received by the receiving chute 38 of the AGV 10. At the front end of the receiving chute 38 in the flow direction, i.e., at the right end in FIG. 2, a blocking element that may have a design as described with reference to FIGS. 5 and 6 may once again be associated with the operating paths 40, 40′. The blocking element in its blocking position prevents empty containers accommodated in the receiving chute 38 from rolling further across the lateral boundary of the AGV 10 due to gravity.

For an automatic delivery of empty containers from the AGV 10 to the container storage area 6, for example, the blocking elements associated with the operating paths 40, 40′ of the receiving chute 38 may then be controlled in their delivery position.

The receiving chute 38 of the AGV is vertically adapted to the delivery chute 42 of the picking shelf 8 in such a way that the front end of the delivery chute 42 in the flow direction is at the same height as in the rear direction of the receiving chute 38 in the flow direction when the AGV 10 is situated in front of the picking shelf 8.

After filled containers from the AGV 10 are delivered to the picking shelf 8 and empty containers are received by the AGV 10, the transport trip of the AGV may be continued with control by the central apparatus. For this purpose, the AGV 10 may either approach further picking shelves to deliver filled containers and/or receive empty containers, or may return to the container storage area 6.

In the container storage area, the AGV 10 may once again receive filled containers in preparation for a further transport trip. A receiving means for automatically or semiautomatically receiving empty containers by an AGV 10 may be provided in an empty container transfer area, which may be formed in the container storage area 6, for example. However, it is also possible according to the invention for empty containers that an AGV 10 has brought from a transport trip to be manually unloaded by logisticians in the container storage area.

According to the invention, it is also possible to provide, in addition to the AGV 10, at least one “empty container AGV” whose primary task is to pick up empty containers from the picking shelves 8. The control of one or more AGVs is generally known to those skilled in the art, and therefore is not explained in greater detail here. In particular, the AGVs used may travel on different routes, wherein bypass loops, for example, may be provided.

In order for the central apparatus, for example, to be always informed of the position of an AGV 10, according to the invention a means for position determination and/or display of at least one AGV may be provided. The exact location of an AGV may thus be determined at any time. This is particularly advantageous when a malfunction occurs.

All of the above-described control operations for controlling the AGV 10 and its components as well as further automatic or semiautomatic components of the production system may be carried out by the central apparatus. However, according to the invention it is also possible for at least a portion of the control operations, in particular of the AGV 10, to be carried out by a controller provided on the AGV 10. The invention thus provides a production system and an AGV 10 by means of which the delivery of material in a production system for the series production in particular of motor vehicles may be largely automated.

One alternative embodiment of an AGV having a transport shelf, designed according to the invention, is explained in greater detail below with reference to FIGS. 8 through 14.

The AGV according to FIGS. 8 through 14 is formed by a self-driving forklift 50 (see FIG. 9) that carries a transport shelf 52 having a base body 54 on which a carrier 56 for containers is situated, of which three containers are denoted by reference numerals 58, 60, 62 in FIG. 8 through FIG. 14. In a departure from the embodiment according to FIGS. 1 through 7, the AGV 50 in this embodiment is controlled by laser navigation.

FIG. 8, analogously to FIG. 2, shows a view in which it is apparent that the carrier 56 has delivery chutes 64, 66, 68 situated one on top of the other, as described with reference to FIGS. 2 through 7. The delivery direction for the delivery of the containers 58, 60, 62 to a picking shelf is denoted by an arrow 70 in FIG. 8.

FIGS. 9 and 10 show the AGV 50 in addition to the transport shelf 52 in a perspective view and a side view, respectively.

According to the invention, the carrier 56 is adjustably situated transverse to the delivery direction 70 and parallel to an essentially horizontal plane relative to the base body 54 of the transport shelf 52 situated on the AGV 50, wherein a means for adjusting the carrier 56 relative to the base body 54 is provided, and is designed in such a way that when an AGV is stationarily situated in front of a picking shelf, the position of the carrier 56 relative to the base body 54, and thus relative to the picking shelf, is adjustable transversely with respect to the delivery direction 70 and parallel to an essentially horizontal plane.

FIGS. 11 and 12, in an enlarged scale compared to FIG. 10, show a detail in the area of a connection of the carrier 56 to the base body 54. A covering 71 of the base body 54 is omitted in FIG. 12 for reasons of clarity.

In the illustrated embodiment, the carrier 56 is situated on the base body 54 so as to be adjustable relative to the base body 54, via a linear guide 72, along an adjustment axis 74 extending transversely with respect to the delivery direction 70 (symbolized by a double arrow in FIG. 11).

Further components of the base body 54 and of the carrier 56 are omitted in FIG. 13 for reasons of clarity.

A drive means, which in the present embodiment has an electromotive drive 76 (see in particular FIG. 13) that is controllable by a control means, is associated with the carrier 56 for adjusting the carrier relative to the base body 54.

The electromotive drive 76 has an electric motor 78 that is operatively connected to a spindle drive 80, which is used to adjust the carrier 56 relative to the base body 54 in the direction of the double arrow 74.

The spindle drive 80 has a stationary threaded spindle 86 that is rotatably supported via rotary bearings 82, 84, and that is in rotary drive connection with the electric motor 78. The unit made up of the electric motor 78, the rotary bearings 82, 84, and the threaded spindle 86 is nondisplaceably connected to the base body 54 of the transport shelf 52.

A spindle nut 88 that is rotatably fixedly connected to the carrier 56 is movable on the threaded spindle 86 in the axial direction thereof. When the threaded spindle 86 rotates under the rotary drive action of the electric motor 78, the spindle nut 88 thus moves relative to the threaded spindle 86 corresponding to the rotational direction of the output shaft of the electric motor 78 in one direction or the other, so that the carrier 56 is adjustable relative to the base body 54 along the adjustment axis 74 in order to laterally fine-position the carrier 56 relative to a picking shelf.

FIG. 14 shows a detail from FIG. 11 in a perspective view.

In the illustrated embodiment, a means for determining the actual position of the AGV 10 relative to the picking shelf is provided, which is in data transmission connection with the control means of the drive means. The means for determining the actual position of the AGV has a sensor means for scanning at least one feature on the picking shelf. The sensor means has an optical sensor means, which in the illustrated embodiment has a laser 90 (see FIG. 12 and in particular FIG. 14) that is designed for scanning an optical feature on the picking shelf. The operating principle of such lasers is generally known to those skilled in the art, and therefore is not explained in greater detail here.

Limit switches 92, 94 (see FIG. 12 and FIG. 13) are provided for switching off the drive 78 in end positions of the adjustment stroke of the carrier 56 relative to the base body 54.

The operating principle of the production system according to the invention is as follows:

The AGV 50 is controlled by the central apparatus for the particular picking shelf, and stops in front of same. The travel controller of the AGV 50 is programmed in such a way that the travel direction of the AGV 50 is transverse to the delivery direction 70, and upon approaching the particular picking shelf, the AGV 50 moves crosswise relative to the delivery direction. In other words, the AGV 50 travels laterally along the particular picking shelf. The laser scans the picking shelf, it being possible to use a mark, affixed to the picking shelf and provided for this purpose, as a reference point. However, it is practical to use a rail of a storage chute of the picking shelf as the reference point.

The actual position of the AGV 50 relative to the picking shelf may thus be determined, based on the scanning of a reference point on the picking shelf by the sensor means 80.

If it is determined, for example, that the AGV 50 has “passed by” the desired setpoint position in which the particular delivery chute of the AGV 10 is in flush alignment with the associated storage chute of the picking shelf, the control means actuates the electromotive drive means 76 in such a way that it moves the carrier 56 relative to the base body 54 opposite the previous travel direction until the carrier 56 is in the desired setpoint position. In this position, the particular container may then be delivered from the AGV 50 to the storage chute of the picking shelf.

If the AGV comes to a stop exactly in a position that corresponds to the setpoint position of the carrier 56 in front of the picking shelf, such fine positioning of the carrier 56 by means of the electromotive drive 76 is not necessary.

If the AGV 50, controlled by the central apparatus, comes to a standstill in a position in which the setpoint position in the travel direction is not yet reached, which once again is determined by the sensor means (laser 90) scanning a reference point on the picking shelf, the control means actuates the electromotive drive 76 in such a way that the carrier 56 is moved relative to the base body 54 in the previous travel direction until the setpoint position is reached.

Fine positioning of the carrier 56 relative to the base body of the transport shelf 52, and thus when the AGV 50 is stationary relative to the picking shelf, is made possible in this way, so that malfunctions due to misalignment of the carrier 56 relative to the picking shelf are reliably avoided. The functional reliability of the production system according to the invention is thus significantly increased.

If the linear adjustment stroke during the adjustment of the carrier 56 relative to the base body 54 in the travel direction or opposite the travel direction of the AGV 10 is not sufficient to bring the carrier 56 into the setpoint position, the control means in cooperation with the central apparatus, which controls the AGV 50, may cause the AGV 50 to move into a position in which the adjustment stroke is sufficient to bring the carrier 56 into the setpoint position.

1-18. (canceled)

19. A production system for the series production of in particular motor vehicles, comprising:
a) a container storage area for storing containers that contain components intended for the production;
b) a plurality of picking shelves, remote from the container storage area, from which components may be removed from containers by workers;
c) a transport means for transporting containers from the container storage area to the picking shelves;
d) the transport means has at least one automated guided vehicle (AGV) on which a transport shelf is situated and which is designed in such a way that containers are or may be automatically delivered from the transport shelf to picking shelves in a conveying direction, the conveying direction (delivery direction);
e) the transport shelf has a base body that is or may be connected to the AGV, and on which a carrier for containers to be transported is situated;
f) the carrier is adjustably situated on the base body, transversely with respect to the delivery direction and parallel to an essentially horizontal plane; and
g) a means for adjusting the carrier relative to the base body is provided, and is designed in such a way that when an AGV is stationarily situated in front of a picking shelf, the position of the carrier relative to the picking shelf is adjustable transversely with respect to the delivery direction and parallel to an essentially horizontal plane.

20. The production system according to claim 19, wherein:
a) the means for adjusting the carrier is designed in such a way that when the AGV is stationarily situated in front of the picking shelf, the means, starting from an actual position, adjusts the carrier relative to the picking shelf into a setpoint position.

21. The production system according to claim 19, wherein:
a) in the setpoint position of the carrier, a delivery path of the carrier is in flush or approximately flush alignment with a receiving path on the picking shelf.

22. The production system according to claim 21, wherein:
a) the delivery path is defined by a delivery chute that is formed on the carrier of the transport shelf, and the receiving path is defined by a storage chute that is formed on the picking shelf.

23. The production system according to claim 22, wherein:
a) each delivery chute or storage chute is defined in each case by two laterally spaced-apart rails, at or on which the containers are or may be guided.

24. The production system according to claim 19, wherein:
a) a drive means is associated with the carrier for adjusting it relative to the base body, and wherein a control means for controlling the drive means is provided.

25. The production system according to claim 24, wherein:
a) the control means is designed and configured for automatically actuating the drive means in such a way that when an AGV is stationarily situated in front of a picking shelf, the carrier, starting from an actual position, is adjusted to a setpoint position relative to the picking shelf.

26. The production system according to claim 19, wherein:
a) the drive means has at least one electromotive drive (78), in particular a linear drive.

27. The production system according to claim 26, wherein:
a) the drive has a spindle drive that is in operative connection with an electric motor.

28. The production system according to claim 19, wherein:
a) a means for determining the actual position of the AGV relative to the picking shelf, and which is in data transmission connection with the control means of the drive means, is provided.

29. The production system according to claim 28, wherein:
a) the means for determining the actual position of the AGV has a sensor means for scanning at least one feature on the picking shelf.

30. The production system according to claim 29, wherein:
a) the sensor means has an optical sensor means.

31. The production system according to claim 30, wherein:
a) the optical sensor means has at least one camera.

32. The production system according to claim 30, wherein:
a) the optical sensor means has at least one laser that is designed for scanning an optical feature on the picking shelf.

33. The production system according to claim 19, wherein:
a) the travel controller of the AGV is programmed in such a way that the travel direction of the AGV is transverse to the delivery direction, such that upon approaching the particular picking shelf, the AGV moves crosswise relative to the delivery direction.

34. The production system according to claim 33, wherein:
a) the sensor means is designed and programmed for detecting, during the crosswise travel, at least one feature on the picking shelf (8) that characterizes the setpoint position.

35. The production system according to claim 28, wherein:
a) the means for determining the actual position of the AGV relative to the picking shelf is in data transmission connection with the travel controller of the AGV.

36. The production system according to claim 19, wherein:
a) at least one AGV is formed by a self-driving forklift that carries the transport shelf.
